(19) United States
(12) Patent Application Publication
(10) Pub. No.: US 2020/0356963 A1
(43) Pub. Date: Nov. 12, 2020

(54) FPGA BASED DATA AND CURRENCY EXCHANGE

(71) Applicant: FG SRC LLC, Dallas, TX (US)

(72) Inventors: Todd Rooke, Colorado Springs, CO (US); Grant Wood, Chaska, MN (US); Joe B. Rogness, Eden Prairie, MN (US); Joel Knighton, Chaska, MN (US); Timothy P. Wilkinson, Apalachin, NY (US)

(21) Appl. No.: 16/938,903

(22) Filed: Jul. 24, 2020

Related U.S. Application Data
(63) Continuation of application No. 15/516,570, filed on Apr. 3, 2017, now abandoned.
(60) Provisional application No. 62/059,783, filed on Oct. 3, 2014.

(51) Int. Cl. G06Q 20/10; G06Q 40/02; G06Q 40/04

(52) U.S. Cl. CPC G06Q 20/10; G06Q 40/04; G06Q 40/02

(57) ABSTRACT

To provide a transaction processing environment with security and low latency, an FPGA based data and currency exchange includes a multi-party trusted data and currency broker processing system. Participants can fund accounts on the exchange and define business rules that govern the distribution of currency and data to other participants. The business rules are encoded onto hardware and transaction information is processed using the hardware.

### CROSS REFERENCE TO RELATED PATENT APPLICATIONS

The present application is a continuation of, and claims priority to, U.S. patent application Ser. No. 15/516,570, entitled “FPGA Based Data And Currency Exchange” filed Apr. 3, 2017, which is a national stage, and claims priority to, PCT Application No.: PCT/US2015/054095, filed Oct. 5, 2015 which claims the benefit of U.S. Provisional Application No. 62/059,783, filed Oct. 3, 2014, the disclosures of which are both herein incorporated in their entirety by this reference.

### BACKGROUND

Current transaction systems for handling information generated by participants generally include two models to facilitate handling of information as well as facilitating transactions between parties. One model includes mainframe systems that are designed to either process a high volume of transactions in batch or to switch or route transactions to processing systems. In this model, upfront costs tend to be higher, but per-transaction processing can be done in high volumes. Another model includes open systems based approach where a server receives and processes transaction requests from a client typically processed through an application programming interface (API). This model scales by introducing further nodes and/or layers which can result in increased latency within the system. Regardless of the model selected, these systems utilize general purpose processors that use shared system resources scheduled for use by an operating system. Systems that use general purpose processers are considered to be the state of the art for efficiency and performance for complex business systems. In these models, as complexity in the processing increases, latency and risk also increase.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

An FPGA based data and currency exchange includes a multi-party trusted data and currency broker processing system. The exchange can receive input messages to conduct exchange transactions. The exchange can be run on one or more FPGA based systems, which receives input messages, processes the messages to evaluate transaction information and produce a result based on evaluating the transaction information.

### BRIEF DESCRIPTION OF THE DRAWINGS

FIG. 1 is a block diagram of participants and interaction with an FPGA data and currency exchange employing a trusted data and currency broker processing system.

FIG. 2 is a block diagram of components of the processing system of FIG. 1 as well as a flow of messages from participants to the exchange and from the exchange to participants during exchange transactions.

FIG. 3 is a flow diagram of steps performed in conducting an exchange transaction based on messages received to the exchange of FIG. 1.

FIG. 4 is a flow diagram of steps performed by an FPGA rules engine during an exchange transaction.

FIG. 5 is a schematic block diagram of a rules engine employing an FPGA unit having a plurality of microcircuits.

FIG. 6 is a schematic block diagram of a microcircuit segment.

FIG. 7 is a flow diagram of operations performed by a microcircuit in processing an exchange transaction.

FIG. 8 is a schematic block diagram of an example flow within a gate assembly.

### DESCRIPTION OF THE PREFERRED EMBODIMENTS

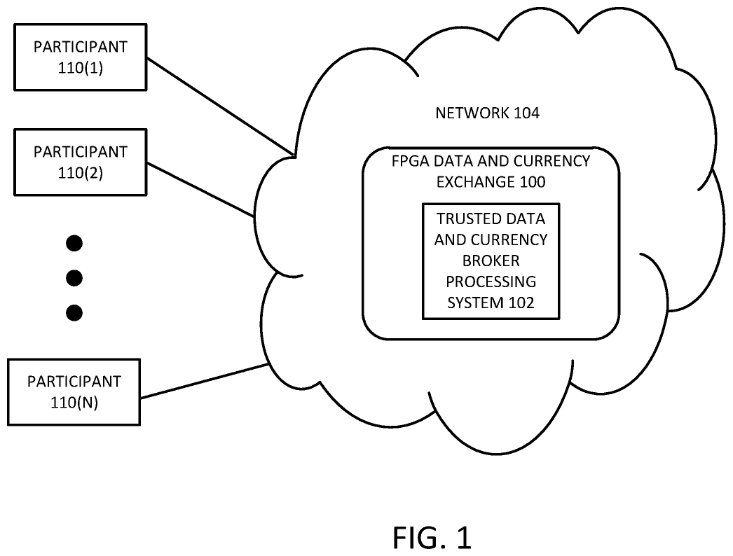

FIG. 1 is a block diagram of an FPGA data and currency exchange 100, which includes a multi-party trusted data and currency broker processing system 102. Through a communications network 104, the processing system 102 can communicate with selected participants or entities 110(1-N). The exchange 100 is embodied on a suitable computing system so as to interact with the participants 110(1-N) in order to perform various functions. In general terms, as illustrated in FIG. 1, the participants 110(1-N) can include various individuals or organizations such as consumers, sponsors, publishers, merchants, service providers and beneficiaries. As used herein, a “participant” or “entity” can refer to information associated with an individual or organization that is used during interaction with the exchange 100, the participants themselves (e.g., an individual consumer) and/or one or more computing devices operated by a participant.

While current payment models facilitate transactions between two parties using one currency, the exchange 100 provides the platform on which multiple parties and/or multiple currencies participate directly in a transaction. In one embodiment, to influence consumer purchasing behavior, the exchange 100 can provide sponsored currency into transactions in real time—online and/or in store. Services provided to and among participants 110(1-N) execute simultaneously within exchange transactions. These exchange transactions follow the business rules (e.g., including transaction requirement information) set by the buying, funding or sponsoring participant as well as the business rules that define the participation among participants within the exchange 100. In one embodiment, the exchange 100 creates a marketplace where the business rules added by the participants 110(1-N) establish the basis for mutually beneficial transactions with other participants and their consumers. In one embodiment, the exchange 100 enforces these business rules through deterministic rule processing. In addition to rule processing, the exchange 100 can implement real-time currency management to manage currency with business rules that define how currency can be minted, branded, escrowed, reserved, earned, redeemed, accepted, expired, released, exchanged, transferred, settled, audited or involved with one or more actions the exchange 100 facilitates.

The exchange 100, in one embodiment, is a single platform that enables multiple participants to create, sponsor and manage currency for transactions. Participants exchange unrestricted and restricted currency subject to the participants' business rules, using the currency as payments, incentives, coupons, offers, rebates, digital gift cards, store credit, loyalty rewards and coalition loyalty rewards. Through use of currency with business rules, exchange participants fund and manage activities using this platform as a trusted data and currency exchange.

In one embodiment, participants fund accounts on the exchange 100 and add business rules to currency that govern the distribution of funds to other participants through the exchange. In one embodiment, participants can use these accounts to launch campaigns that seek to influence and compensate consumers and other participants for taking specific actions. In addition to determining how currency flows in exchange transactions, these business rules also govern sharing information among participants. When participants' business rules intersect, they establish the basis for mutually agreeable transactions. The exchange 100 facilitates those transactions, exchanging data and currency among participants according to the participants' business rules. The exchange 100 operates on the principle that data, not just currency, has value. The exchange 100 applies participants' business rules to data to determine how data flows, is used by and shared between participants 110(1-N). Data is also subject to appropriate restrictions established through the exchange 100 including security and availability. Transparency and control in exchanging data through these business rules allows each participant to express and execute its business according to its core values and conform to applicable data protection laws.

In order to handle a high volume of messages sent to the exchange 100 for processing by system 102, as well as processing transactions between and/or among multiple participants in the exchange 100, several approaches can be utilized to implement a processing system 102 that can provide high availability, low latency, security, privacy and other features as desired. Example processing functions include contextual event processing and deterministic processing. In one implementation of deterministic processing, a stream-triggered deterministic processing approach is utilized. In this approach, data input sent to processing system 102 is used to program the hardware gates within an FPGA processor and the data input is processed using the programmed hardware gates.

It is worth noting that access to the processing system 102 by a participant 110(1-N) can be facilitated through a suitable computing device such as a personal computer, tablet, smart phone, game console, set top box, television, ATM or the like, which communicates with the system 102 through a suitable communication network such as the Internet. Processing system 102 can be implemented on a computing system such as a server accessible through the Internet and equipped to access information associated with the participants 110(1-N).

In the description herein, reference is made to accompanying drawings which form a part hereof, and in which is shown by way of illustration specific examples in which the disclosure may be practiced. It is to be understood that other examples may be utilized and structural or logical changes may be made without departing from the scope of the present disclosure. The following description, therefore, is not to be taken in a limiting sense, and the scope of the present disclosure is defined by the appended claims. It is to be understood that features of the various examples described herein may be combined, in part or whole, with each other, unless specifically noted otherwise.

While the disclosure refers to illustrative embodiments for particular applications, it should be understood that the disclosure is not limited thereto. Modifications can be made to the embodiments described herein without departing from the spirit and scope of the present disclosure. Those skilled in the art with access to this disclosure will recognize additional modifications, applications, and embodiments within the scope of this disclosure and additional fields in which the disclosed examples could be applied. Therefore, the following description is not meant to be limiting. Further, it is understood that the systems and methods described below can be implemented in many different embodiments. The operation and behavior of the systems and methods presented are described with the understanding that modifications and variations of the embodiments are possible given the level of detail presented.

References to “one embodiment,” “an embodiment,” “in certain embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

Some concepts presented herein relate to the performance of data processing systems in an information network. Example systems that can utilize these concepts are described in U.S. Pat. App. Pub. Nos. 2012/0166262 and 2013/0126605, 2013/0117084, the contents of which are hereby incorporated by reference herein. It will be appreciated that the concepts herein can be implemented with one or more devices having a processor such as a general purpose computer or other data processing device such as a tablet or phone. The devices can further be equipped to communicate using one or more communication links including both Internet and non-Internet forms of communication (e.g. WiFi, Bluetooth, infrared, near-field communication, cellular, sound, and human inaudible sound). In one embodiment, the devices include the ability to render content, for example text, images, audio and video, in presenting information so as to facilitate communication with one or more users.

System 102 may include a variety of media, including computer-readable storage media and/or communications media. These two terms are used herein differently from one another as follows. Computer-readable storage media can be any available storage media that can be accessed by devices on system 102, is of a non-transitory nature, and can include removable and non-removable media that is either volatile or nonvolatile in nature. There are several examples of computer-readable storage media (e.g., computer-readable storage media storing computer-executable instructions that when executed by at least one processor cause the at least one processor to perform a specified function). By way of example, and not limitation, computer-readable storage media can be implemented in connection with any method or technology for storage of information such as computer-readable instructions, program modules, structured data, or unstructured data. Computer-readable storage media can include, but is not limited to, RAM; ROM; EEPROM; flash memory or other memory technology; CD-ROM, digital versatile disk (DVD), or other optical disk storage; magnetic cassettes, magnetic tape, magnetic disk storage, or other magnetic storage devices; or other non-transitory media which can be used to store desired information. Any such computer-readable storage media may be part of system 102. Computer-readable storage media can be accessed by one or more local or remote computing devices, via access requests, queries or other data retrieval protocols, for a variety of operations with respect to the information stored by the medium.

On the other hand, communications media typically transmits computer-readable instructions, data structures, program modules, or other structured or unstructured data in a data signal such as a modulated data signal, e.g., a carrier wave or other transport mechanism, and include any information delivery or transport media. The term “modulated data signal” refers to a signal that has one or more of its characteristics set or changed in such a manner as to encode information. By way of example, and not limitation, communication media include wired media, such as a wired network or direct-wired connection, and wireless media such as acoustic, RF, infrared and other wireless media.

In one embodiment, system 102 constitutes all or part of a service to provide goods or services in response to a request generated by a consumer through interaction with a button or input, which may be physical or virtual in nature. In one embodiment, the button may be embedded on a social media site or standalone website, accessible through a computer, cellphone, tablet, or other general-purpose computing device. In one embodiment, the button may be embedded within a standalone application on a computer, cellphone, tablet, or other general-purpose computing device. In one embodiment, the button may be embedded within dedicated hardware (e.g., a television, vending machine, or point of sale). By interacting with the button, the user may purchase goods or services. It is important to note that the goods or services available for purchase do not need to be hosted or provided by the same site, participant or entity providing the button. In one embodiment, these goods or services may have several variations upon the goods or services from which to select. Alternatively, or in addition to, these variations may be dynamically generated based upon a combination of contextual data and targeting rules. For example, digital media assets may be dynamically created, modified, or synthesized to include promotional material, advertising, or other content.

Consumer interaction with the button will trigger input on an input stream, according to one embodiment. Information identifying the consumer is transmitted over this stream, permitting system 102 to identify the user. In one embodiment, targeting rules may determine the eligibility of the consumer and/or modify the goods or services presented to the consumer for purchase. If the user is eligible, system 102 may locate the consumer's currency balances in internal or external systems/networks. According to one embodiment, currency rules may limit the set of balances eligible to be used in part or in whole as part of the transaction. In one embodiment, system 102 may use input stream information, contextual information and/or targeting rules to present the consumer with available advertisements, engagements, and/or alternative earning opportunities to complete the transaction. Once the consumer has selected or provided a suitable funding source, system 102 will transfer funds to complete the transaction. In one embodiment, the goods or services may be delivered virtually (e.g., by adding the goods or services to a user accessible catalog, by transmitting a license or redemption code to a destination made available through contextual information, or by streaming content directly to a general-purpose computing device or dedicated hardware). In one embodiment, the goods or services may be delivered physically to a location (e.g., a location provided by contextual data or a location input at time of transaction).

In one embodiment, consumers are individuals targeted for advertising and/or input of information based on interaction with the processing system 102. Potential information associated with each consumer includes demographic information (e.g., age, sex, and location), psychographic information (e.g., interests, activities, and opinions), currency-based balances, currency-based account information (e.g., a bank account), purchasing history, notification information (e.g., email address, cell phone number), networking account information including social networks (e.g., Facebook, Twitter, LinkedIn), authorization preferences, privacy preferences, etc. In particular, each consumer is associated with a profile, including both a persona and an activity score(s).

In one embodiment, sponsors are associated with an organization focused on providing incentives to other participants within the exchange 100. In one example, a sponsor directs consumers to advertising and/or information gathering related to a particular brand, product, or service. Such example sponsors include a retailer, advertising agency, research organization, non-profit organization, governmental entity, affiliate, etc. A sponsor can initiate a campaign to either advertise a particular brand, product, service, etc. and/or collect information from consumers about a particular brand, product, service, etc. In one embodiment, the sponsor can indicate a target group based on persona and/or activity score of a consumer profile. Moreover, a consumer may have brand-specific attributes that can indicate a match for a particular campaign. For example, an affiliate sponsor can be a sports organization such as the National Football League or Professional Golf Association that maintains relationships with a number of different consumer that share similar interests (e.g., a particular sport). As such, a sponsor campaign's engagement with a consumer can be targeted to a selected group. The campaign can include a particular budget that is monitored and distributed by the data processing system 102.

In another embodiment, sponsors are organizations focused on providing incentives related to a particular behavior or specific payment arrangements with participants within the exchange 100. In another embodiment, sponsors include employers, healthcare insurers, healthcare providers, utility companies, and other organizations intending to influence behavior. One such sponsor is the U.S. Department of Agriculture, which facilitates programs such as Supplemental Nutrition Assistance Program (SNAP), Women, Infants, and Children (WIC), and others. SNAP, for example, is facilitated through an electronic system known as Electronic Benefit Transfer (EBT). EBT allows SNAP participants to authorize transfer of governmental benefits to selected merchants. As part of the program, SNAP utilizes an approved product list (APL) of foods that program recipients can buy (e.g., breads, fruits, vegetables). In like manner, SNAP utilizes a product list of foods that participants cannot buy using EBT funds (e.g., beer, cigarettes, pet foods).

In another embodiment, utility companies can also act as sponsors so as to assist in contributing capital costs for energy efficient devices. For example, a utility company can provide an incentive to consumers for reducing energy usage and/or for using energy efficient devices. Within exchange 100, devices associated with a consumer and in communication with the processing system 102 can provide an indication of the consumer's device usage (e.g., turning on/off a light bulb and/or turning up/down a thermostat). Based on such indications of device usage, the consumer can be compensated as directed by the utility company sponsor. In like manner, healthcare insurers and providers as well as employers can incentivize particular behaviors of consumer based on information provided to the system 102 (e.g., checking in at a health club, specific targets/achievements measured through personal monitoring systems like Apple's HealthKit, purchasing behavior, etc).

In one embodiment, publishers provide a point of contact between a consumer and the processing system 102, often referred to as a channel. Examples of such include a web content provider, media network, social network, gaming company or console, etc. In one embodiment, if a publisher displays an engagement that ultimately leads to a transaction with a consumer, the publisher can receive compensation, such as a percentage of the transaction or a fixed fee. In another embodiment, a publisher can receive compensation for recruiting sponsors and facilitating the initiation of a campaign as compensation events are completed. In another embodiment, a publisher may also be a merchant selling goods or services through the processing system. In another embodiment, a publisher may present an offer to a consumer and if the consumer initiates a reservation (or clip) to both indicate intent to purchase and secure the ability to redeem the offer within a given time window, the publisher can receive compensation.

Merchants are associated with an organization that sells products and/or services. In one embodiment, a merchant may sell digital media, digital games, digital songs, digital software files, physical goods, household services, etc. In one example, the merchant can form a point of contact with the consumer. In such instances, the merchant can be associated with a point of sale device, a payment terminal, interactive platform or other device that can communicate with one or more of the other participants 110(1-N). Moreover, the merchant can be one and the same as the sponsor or independent therefrom. In one embodiment, a merchant can present an offer to a consumer, which can include a coupon.

Authenticators are third-party organizations that include information about one or more of the consumer so as to provide independent verification of the consumer. In one embodiment, authenticators include social and/or networking platforms (e.g., Facebook, Twitter, LinkedIn, Pintrest, Google+), OpenID and/or OAuth providers (e.g., Gmail, Yahoo!, AOL), companies that do business with consumers (e.g., a cell phone company), digital identity providers (e.g. AnchorID), etc. Authenticators can be utilized by the processing system 102 to assist in verifying attributes of consumer, which can directly change an activity score for a consumer. For example, the system 102 may send a code via text message to a cell phone of a consumer. If the consumer then delivers this code to the system 102, it can indicate that the consumer is dependable and reachable. Thus the activity score associated with the consumer can be adjusted accordingly. In one embodiment, Authenticators can include consumer data platforms (e.g. Axciom, Experian, FICO) and government agencies. In one embodiment, the system 102 associates unique activity scores for each participant with which a consumer interacts. In another embodiment, authenticators can incorporate facial recognition, machine learning, social biometrics, and artificial intelligence to verify the authenticity of customer identities (e.g. Socure.com).

Non-profits or beneficiaries are companies organized as non-profit tax entities under a suitable tax designation similar to that found in United States Code 26, Section 501(c)(3). Any participant within the data processing system can direct any of their respective portions of any compensation event, offer, or transaction to a non-profit. In one embodiment, the non-profit can be one and the same as the sponsor, publisher, merchant, authenticator, or independent therefrom. In another embodiment, participants can contribute some or all of their portion of compensation incentives to the non-profit.

It will be appreciated that the participants 110(1-N) can communicate directly to data processing system 102 through communications network 104 or through payment facilitators. As such, the participants 110(1-N) can include or be associated with one or more payment processing facilitators such as point of sale systems (e.g., in the case of a merchant), acquiring processors, payment networks, issuing processors, banks (e.g., banks that hold financial account information for participants 110(1-N)), wallet providers (e.g., providers that request, hold, and transmit payment tokens and/or account number information), mobile service providers (e.g., cellular network service providers that have a billing relationship with consumers) and others that ultimately facilitate balance transfers of currency in response to a purchase transaction. The processing system 102 is equipped to interface with one or more of these facilitators as desired, it being appreciated that each of these facilitators can be participants with exchange 100 either through the participants 110(1-N) or through independent connection to communications network 104, in which the facilitator provides independent services to one or more of the participants 110(1-N).

Participants 110(1-N) discussed above are not intended to be limiting. Other participants can further be used that include information and interact with exchange 100 in various ways. For example, affiliates can be participants and persons or companies that facilitate participant interaction or payment through a system, process, license, or other means. In one embodiment, a flat fee may be directed to the affiliate in the compensation event, in another embodiment a percentage based and volume/value based compensation models are utilized.

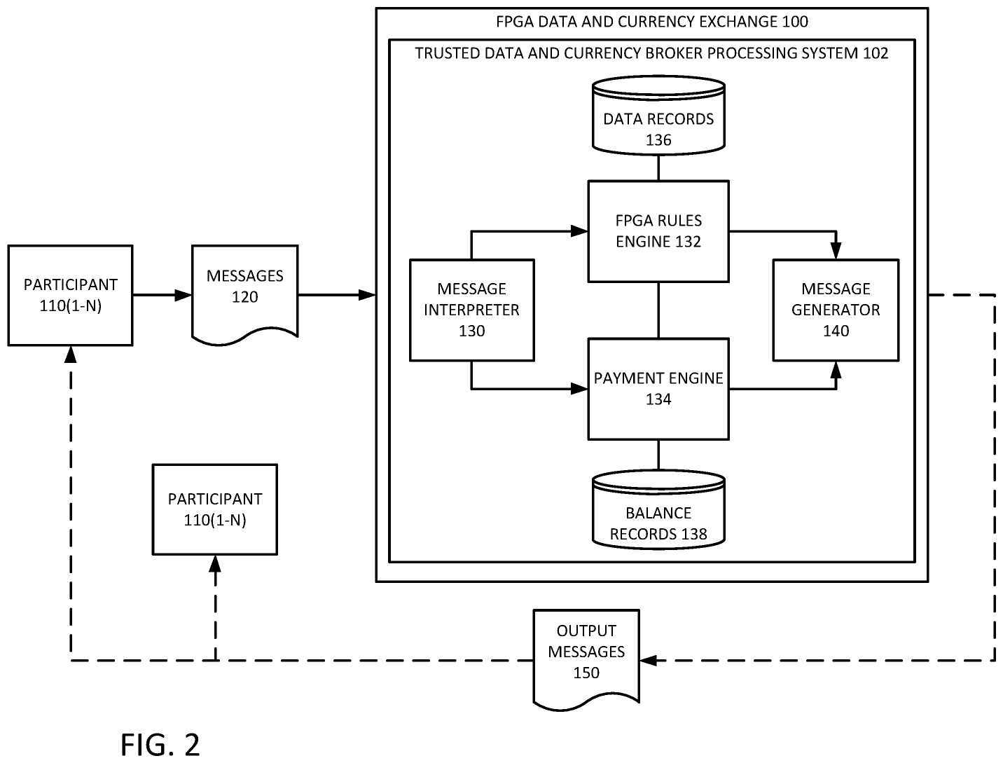

As illustrated in FIG. 2, participants 110(1-N) are configured to transmit network input messages 120 to the processing system 102 through exchange 100 to conduct exchange transactions. The processing system 102 includes a message interpreter 130 that understands the content within the messages 120 and can facilitate processing of the messages 120, for example by translating protocols for the messages 120 to another form and/or routing the messages for processing. In particular, the message interpreter 130 can send data to an FPGA rules engine 132 and/or a payment engine 134. Rules engine 132 accesses data records 136 (e.g., containing contextual information) based on the messages 120 to produce a result. In one embodiment, rules engine 132 and data records 136 include logic that, when implemented, conducts an exchange transaction ultimately producing a result that is an execution of a contract associated with exchange of data and/or currency between or among multiple participants 110(1-N).

The payment engine 134 maintains verifiable balance records 138 of currency for each of the participants 110(1-N). Each of the balance records 138 is associated with a unique balance and can contain information for what participant owns the balance, a value for the balance, currency rules for the balance, and other information as desired. In one embodiment, the payment engine 134 is maintained by the processing system 102 through the exchange 100, where in another embodiment the payment engine 134 can be a separate engine that maintains a balance for participants, wherein system 102 can communicate changes to balance records 138 and a payment engine 134 operates to update the balance records 138 as communicated by the exchange 100.

In one embodiment, a contract includes business rules, currency rules and data rules. The business rules define how and when contracts between or among multiple parties are executed, whereas currency rules define restrictions on how currency can be used (e.g., by merchant, brand, product, location, timeframe). In one embodiment, currency rules can define restrictions based on currency properties of multiple dimensions including but not limited to transferability, expiration, exchangeability, acceptance, and the transfer of currency between the multiple participants. In one embodiment, data rules define what information related to an event will be redacted, transformed, tokenized, echoed, enhanced and in what forms the data can be presented to each of the multiple participants 110(1-N) in network 100.

Without limitation, representative example rules can include, either alone or in combination:

1. Currency X must be used at Y merchant.

2. Currency X must be used at either Y or Z merchants.

3. Currency X must be used within Y time period.

4. Currency X must be used within specific indoor or outdoor geo-fence.

5. Currency X must be used in a transaction with merchant Y prior to Z date.

6. Currency X must have been reserved prior to use.

7. Currency X must be used in a transaction with manufacturer Y product.

8. Currency X must be used in a transaction with manufacturer Y's specific UPC.

9. Currency X must be used by Y person.

10. From a particular merchant, only non-identifiable consumer information can be shared regarding a particular product purchased in a transaction.

Subsequent to processing of messages 120, a message generator 140 can be utilized by the processing system 102 in order to generate one or more messages in the exchange 100, an example being shown as output messages 150. Network output messages 150 can be sent to other participants 110(1-N) in the exchange 100 or sent to other data processing applications. Example data processing applications include payment engines, data aggregators, data analyzers, auditing applications, targeting applications, acquiring processor applications, issuing processor applications, independent network applications, and others outside the exchange 100. It is important to note that these processing applications can also be implemented within the exchange 100 as desired. Output messages 150, when generated, can sent back to the participant 110(1-N) that originated the input message 120 and/or to other participants 110(1-N). The message 150 can take various forms, such as an acknowledgement that an input message 120 was received, a result of processing the input message 120, an indication of funds available based on the input message 120, and others.

One example use of processing system 102 is as a token service provider. A requesting participant 110(1-N) issues a token request message 120 so as to create a chain of trust authenticated by the processing system 102 between the requesting participant 110(1-N) and one or more other participants 110(1-N) in the exchange 100. For example, a device used by a consumer can originate a token request message 120 to use for facilitating a transaction. The processing system 102 then issues an output message 150 that includes a token that the requesting participant can use to securely communicate with a receiving participants. In other embodiments, tokens can be sent periodically, intermittently, with random key combinations, and in other various ways as desired. In a further embodiment, the processing system 102 can also issue a token output message to a receiving participant with information for decrypting the token or otherwise providing assurance of authentication of the requesting participant.

In one embodiment, input messages 120 are provided to exchange 100 from a point of sale during a financial transaction. For example, a consumer may present an offer or be presented an offer from a merchant, or present an identifier during a retail purchase transaction. The consumer prepares a basket of one or more items for purchase and transaction information is assembled for the purchase transaction. System 102 facilitates the transaction between the consumer and the point of sale and can operate to manage the offer and settle the transaction as discussed in more detail below. In one embodiment, the point of sale system or terminal encrypts or tokenizes properties or collections in the transaction (such as the basket, location, or personally identifiable information of a consumer) using keys and/or seeds provided by system 102 at the time of the transaction and/or at a time prior to the transaction. In one embodiment, the keys and/or seeds used by the point of sale for tokenizing or encrypting are derivable by system 102 through known key management and distribution policies, contextual transactional information, and/or any combinations known between the systems. In another embodiment, the keys and/or seeds used to encrypt or tokenize the properties or collections in the transactions are provided by the consumer's computing device to the point of sale terminal or system. In one embodiment, the point of sale system encrypts or tokenizes the properties or collections in the transaction in a streaming process that reduces the time expended at the end of the transaction by handling the encryption in smaller chunks. In one embodiment, the generated basket stream can be sent continuously to the system 102 and/or another participant as a part of the communication path.

In one embodiment, a transaction facilitated by exchange 100 using system 102 for a purchase can be based on an offer presented to the consumer. An offer, as used herein, can be any form of coupon, discount, rebate, proposal, etc. associated with consumer activity and presented as an incentive for the consumer to commence a specified transaction. Stated another way, an offer provides compensation, discount, or other form of value to a consumer for performing at least one qualifying action attached to the offer. Further, currency associated with the offer can have rules attached that provide the requirements for the use of the currency. In one embodiment, currency rules can incorporate many dimensions, including but not limited to and singularily or in combination: product identifier, service identifier, UPC, collection of UPCs, brand, manufacturer, category, merchant, time, location, and device.

In one embodiment, the consumer is presented with the offer and communicates one or more identifiers (e.g., associated with the offer, with the consumer or both) to the point of sale. In one example, the point of sale can be a cash register at a conventional brick-and-mortar retail store or a website presented to the consumer, whereas the offer could be presented to the consumer digitally through the Internet. The transaction between the consumer and the point of sale includes transaction information such as a customer identifier, a merchant identifier, a date and time, a level of interactivity, a consumer location, a merchant location and/or other information. The consumer can create a reservation to reserve a particular offer, such as a discount on goods. Once a consumer has reserved the offer, the reservation can be counted against a budget. Furthermore, the reservation can be subject to a particular expiration, which ultimately can be released if not utilized in a specified time frame or through the action of an alternative expiration trigger.

Further to the transaction information identified above, the transaction information can include a basket (either physical or virtual in nature) prepared by the consumer containing one or more goods and services for purchase. In one embodiment, items in the basket can each include a Universal Product Code (UPC), or equivalent, that uniquely identifies products within the basket. The point of sale interfaces with the exchange 100 to identify the consumer and offer based on information presented by the consumer (or consumer device) at the point of sale.

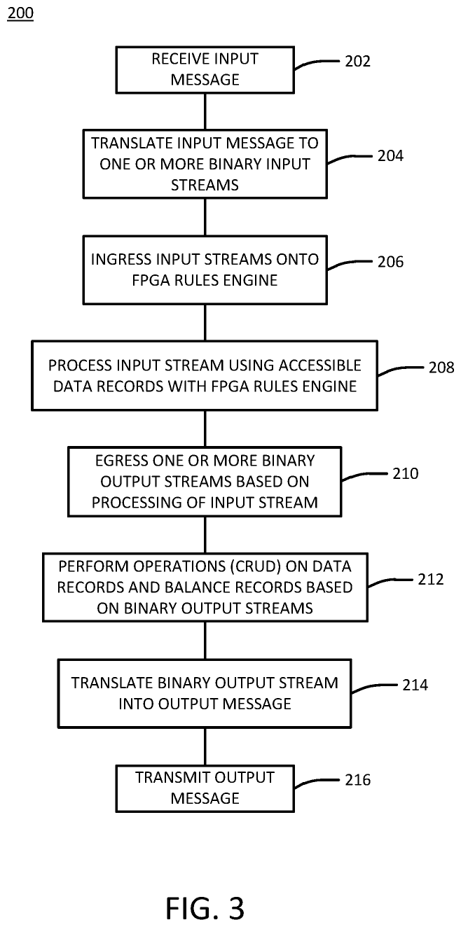

With reference to FIGS. 2 and 3, FIG. 3 is a flow diagram of a method 200 performed by the exchange 100 and system 102 when conducting an exchange transaction. At step 202, an input message is received from a participant 110(1-N). The message can be sent using various protocols and/or formats to enhance authentication and verification of the message as well as be configured to reduce processing time needed to process contents of the message.

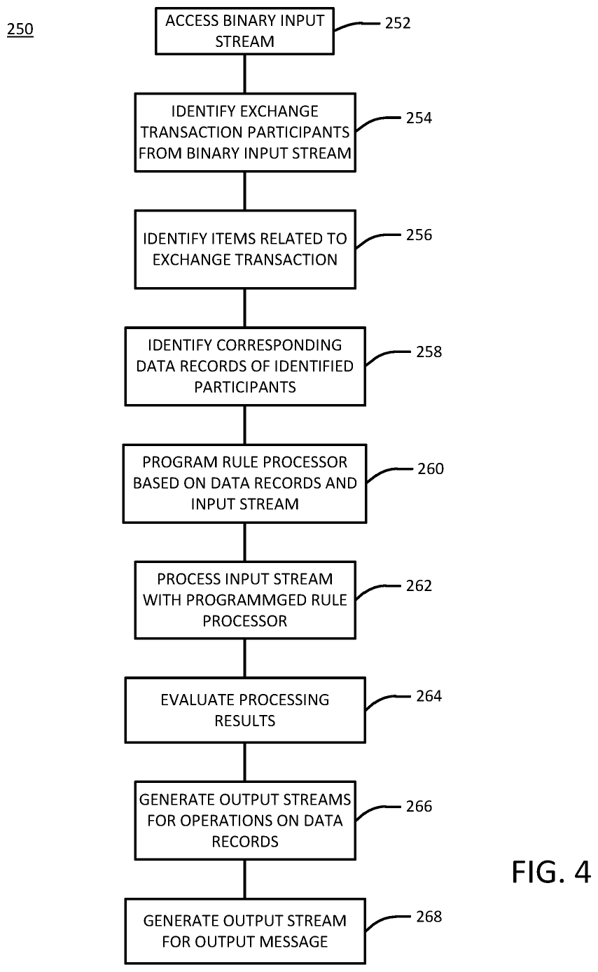

At step 204, the input message is translated to one or more binary input streams to be processed by the rules engine 132. The binary input streams are then ingressed onto the FPGA rules engine 132 at step 206. Using accessible data records 136, the input stream is processed with the FPGA rules engine 132 at step 208. As discussed with more detail in FIG. 4 below, one or more binary output streams 210 are egressed from the FPGA rules engine 132 at step 210 as a result of processing the input streams. Based on the output streams, CRUD (create, read, update, delete) operations on the data records 136 and balance records 138 can be performed at step 212. Additionally, one or more of the binary output streams can be translated into one or more output messages at step 214. Output messages are transmitted at step 216.

FIG. 4 is a flow diagram of a method 250 performed by FPGA rules engine 132. It should be noted that one or more of the steps in method 250 can be performed in parallel with one another or serially as desired. At step 252, a binary input stream is accessed. The binary input stream contains information that is interpreted by the rules engine 132 to facilitate an exchange transaction. Using the binary input stream, exchange transaction participants are identified at step 254. For example, a consumer and a merchant may be identified from the binary input stream. Based on the identified exchange participants, corresponding data records of identified participants can be identified at step 256. At step 258, items related to the exchange transaction are identified. In one embodiment, this step involves identifying items that have been presented for purchase in an exchange transaction.

Given the identified data records gleaned from the input stream, the hardware gates within the FPGA are programmed step 260. These hardware gates are programmed such that, when the input stream is processed through the hardware gates, it can be determined if the exchange transaction can be facilitated given business rules of associated participants. The input stream is processed at step 262. For example, in a purchase transaction between a consumer and a merchant, the hardware gates can be programmed according to particular offers that are associated with the consumer. The input stream in this case will contain items presented for purchase and, if a particular item matches an offer, will be redeemed according to terms of the offer. At step 264, the processing results are evaluated to determine if other processing is needed or whether other processed streams should be combined or otherwise altered to produce a final result. Based on the evaluation and further processing if desired, output streams are generated for operations on data records at step 266. For example, CRUD operations can be performed on contextual information. At step 268, one or more output streams for the output message can be generated as desired.

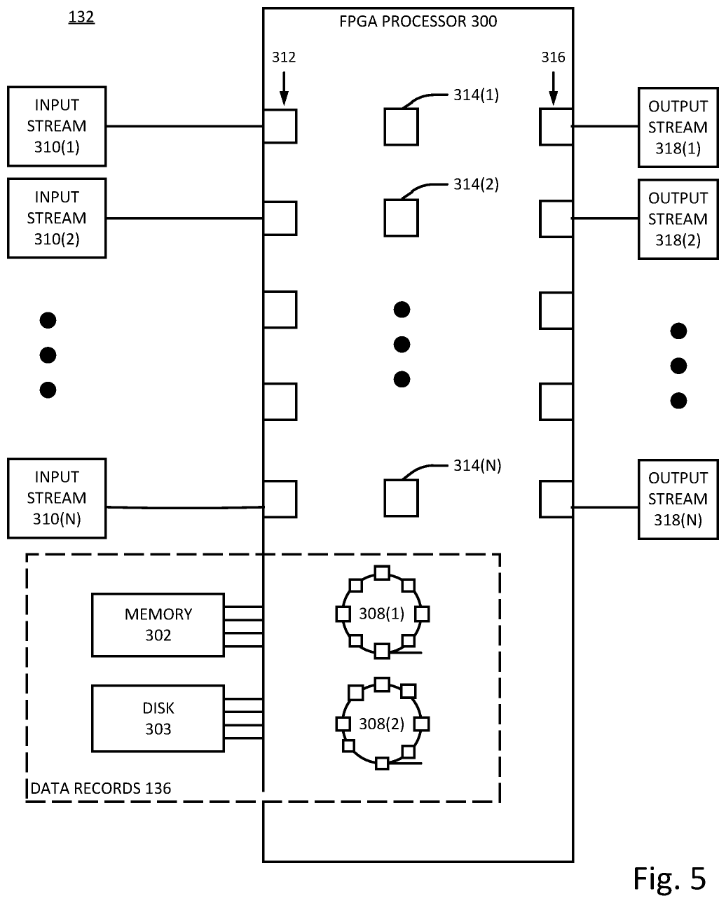

FIG. 5 is a block diagram of rules engine 132 employing an FPGA processor 300 according to one embodiment. In one embodiment, deterministic rules engine 132 includes one or more FPGA processors 300. Engine 132 also includes data records 136 stored as contextual information. The processor 300 has access to data records 136 through access to memory 302, disk 303 or other storage means, such as memory loops 308 stored natively in the processor 300. In one embodiment, processor 300 does not include an operating system, but rather includes wiring with instructions configured to process data received by the exchange 100. Processing without an operating system can significantly reduce the attack surface for malicious activity and remove the opportunity for malware, viruses, or exploits in operating systems and commonly used programs and code. In one embodiment, the use of FPGA processors 300 are deployed as secured appliances. In one embodiment, the FPGA processor 300 is used in conjunction with a Trusted Platform Module (TPM) to provide attestation of the FPGA system. In another embodiment, the FPGA processor 300 is configured using a bytecode which has been cryptographically signed by a second trusted system and verified to be valid by a key sealed inside the TPM. In another embodiment, the key used to verify the bytecode's cryptographic signature is provided by a second external trusted system, which may or may not be a hardware security module (HSM) appliance.

In one example, FPGA processor 300 comprises an FPGA (field programmable gate array) and logic to control the FPGA. Processor 300 is configured to receive input streams 310 (shown as streams 310(1-N)) to an ingress 312. In one embodiment, processor 300 is implemented on a single chip, card, cartridge, or other device that employs a hardware unit. For example, the device could be a mobile device, tablet, phone, computer, server, and mainframe. Multiple processors 300 may be communicatively connected together in a common chassis, rack, or alternative container of hardware units. In some embodiments, rules engine 132 or processor 300 could be comprised of a device that could be worn, carried, used in groups, stand alone, or belong to a loosely coupled network.

In one embodiment, secure cryptography processing and key management that meets financial industry and health industry standards such as PCI-DSS, HIPAA and NIST standards for security and compliance as required for financial transaction processing, payment authorization, data protection, tokenization, and others is used within the FPGA processor 300. In one embodiment, the common chassis can also have a tamper-resistant HSM embedded in the chassis or implemented on a single card or cartridge contained within the chassis. In another embodiment, the chassis itself can be implemented as secure and tamper-resistant such that operations can halt for the entire chassis and/or HSM if the chassis detects that it has been compromised. In one embodiment, the HSM is implemented using FPGA processor 300. In another embodiment, a TPM can be used in conjunction with the HSM or in concert with the HSM on the chassis or independently on the FPGA processors 300.

In one embodiment, engine 132, and in particular FPGA processor 300, can evaluate contents of the basket of goods for purchase by the consumer to match any offers that are associated with the consumer as they pertain to the contents of the basket. Alternatively, or in addition to, a merchant may present a matching offer based on one or more of the products in the basket and/or based on a total of all products in the basket. Adjustments to the transaction amount based on the offers can be facilitated by the exchange 100 with varying levels of integration with the point of sale.

The FPGA processor 300 looks at the items that are in the basket, evaluates all of the offers that are reserved for the consumer and all of the currencies that the consumer has available to apply to the transaction based on the currency rules (e.g., both merchant and brand currencies) and the respective currency rules and redemption exchange rates between the relevant merchant and brand currencies, and applies some or all of the offers and some or all of the currencies in order to compute an adjusted amount that needs to be settled with outside network funds.

In one embodiment, data records 136 includes user information, reservations, and offer rules. A set of offer rules is associated with each offer. The offer rules can be based on a variety of factors, including but not limited to consumer identity, merchant id, store id, banner name, store location, checkout lane, checker id, basket quantity, basket total, sales tax rate, sales tax total, product category quantity and total, item SKU(s) and/or item UPC(s), item price, discounted price, applicable coupon, item quantity, item description, item taxable price, time or date, and can be combined together or used singularly to determine whether the offer's requirements have been met. An example offer rule, intended for illustration and not to limit the expressive possibilities of the rules, can determine whether a specific consumer purchased a quantity of five of a single item with a specific UPC priced between a maximum value and a minimum value and also purchased a minimum number of items from a specific store department between 12:00 pm local time and 1 pm local time. When a particular consumer reserves an offer, that reservation is stored in data records 136 and is associated with that particular consumer, and the reservation contains a reference to the offer rules for the reserved offer. After payment has been made to the consumer in accordance with the offer, a payment record is received by the engine 132 and the reservation is deleted from data records 136. Reservations can also be automatically deleted if they have expired. In an example of deterministic basket processing according to one embodiment, different input streams 310 can be used, for example to convey offer rules, user information or user context, reservations of offers, payment information and baskets to optimize FPGA processor 300.

In one embodiment, the streams 310 are transferred using Kafka queues, and each of the elements represents a Kafka queue or a topic in a Kafka queue to ingress 312. Ingress 312 can include one or a plurality of different input points to the processor 300. From ingress 312, the FPGA processor 300 uses a plurality of microcircuits 314(1-N) to monitor the input streams 310 for items of interest. After processing by the plurality of microcircuits 314(1-N), resulting data is output to egress 316 as output streams 318(1-N). When an item of interest is identified by a microcircuit 314(1-N) of FPGA processor 300, the particular microcircuit 314(1-N) takes actions based on its current logic configuration. In one embodiment, more than one of the microcircuits 314 can take actions simultaneously depending upon a configuration of the processor 300. The actions may include removing something from memory 302 or disk 303, replacing something in data records 136 (e.g., memory 302 or disk 303), or creating a new record in the data records 136. Thus, in a basket processing embodiment, data records 136 may be updated based on offer rules, user information, reservations, payment information and basket information. Data records may also be updated or provided via memory loops 308 configured within the FPGA processor 300.

In one embodiment, a basket is processed by FPGA processor 300 based on information contained in the basket and information stored in data records 136 and a basket response is generated to an output stream 318. For example, FPGA processor 300 may identify the consumer associated with the basket and identify all the reservations associated with the identified consumer, and then the offer rules for each reserved offer are streamed into the FPGA processor 300. In one embodiment, the baskets are implemented as JavaScript Object Notation (JSON) documents. In another embodiment, the baskets are embedded in ISO 8583 or ISO 20022 documents.

The offer rules for each reserved offer are streamed to the FPGA processor 300. The FPGA processor 300 is reconfigured based on the offer rules, and the reconfigured hardware checks the basket to see if anything matches the reserved offers. In one embodiment, the FPGA processor 300 is reconfigured with an FPGA rules processor comprised of hardware gates that can be programmed perform specific operator functions based on rules that can be streamed through the hardware gates to determine active specific function after the processor 300 has been programmed. In one embodiment, the rules that program the hardware gates can be offer rules, and each gate may have the capability to be programmed to perform one of many potential operator functions as described herein. In another embodiment, the rule processor can be programmed by the offer rule to perform a rule check using pre-programmed hardware gates, each selected for its specific function to be used in conjunction with other preprogrammed and reprogrammed hardware gates to execute a rule check.

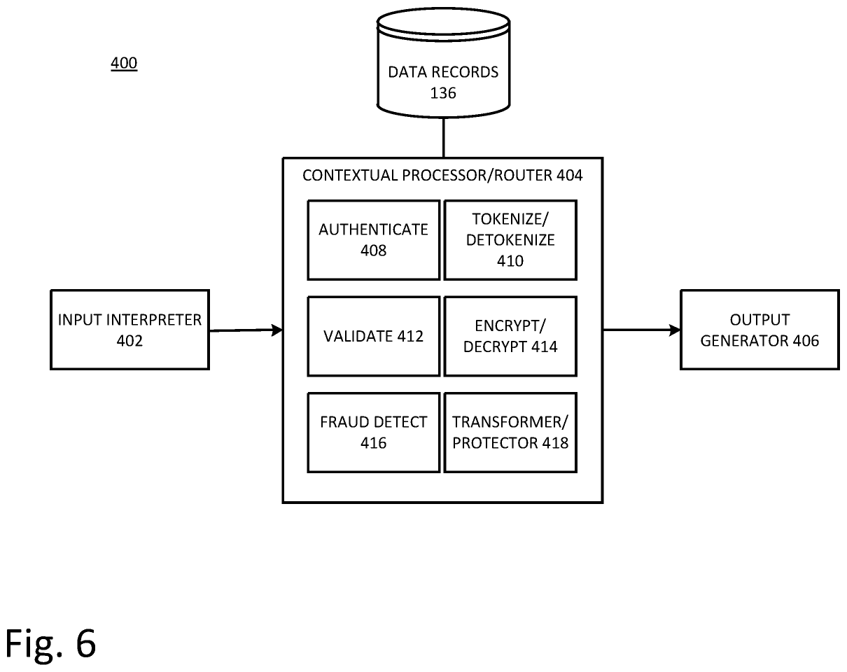

Each microcircuit 314 is formed of one or more microcircuit segments, each either running in parallel with one another, serially or in any combination thereof. FIG. 6 is a block diagram illustrating functional elements of an example microcircuit segment 400. As shown in FIG. 6, the microcircuit segment 400 includes an input interpreter 402, a contextual processor/router 404 and an output generator 406. The contextual processor/router 404 includes one or more units as desired to process input streams, including an authenticate unit 408, a tokenize/detokenize unit 410, a validate unit 412, an encrypt/decrypt unit 414, a fraud detect unit 416 and a transformer/protector unit 418. In one embodiment, the units utilize the HSM and/or TSM features described herein.

Input interpreter 402 operates to interpret one or more of the inputs presented to the microcircuit segment 400. In one embodiment, the input interpreter 402 determines a particular type of input that is presented and whether the particular input is relevant to the microcircuit segment 400. For example, a particular microcircuit segment may be configured to extract items for purchase from a basket and ignores other data. As such, if a particular input is not relevant, the input interpreter 402 can discontinue consuming the particular input.

If the input interpreter 402 indicates that the particular input is relevant, data from the input is passed to the contextual processor/router 404. The contextual processor/router 404 may then access data records 136 in order to process the input in light of the data records 136. In one embodiment, the contextual processor/router 404 performs a CRUD operation on the data records 136. Alternatively, or in addition to, the contextual processor/router 404 can route information to one or both of the transformer/protector 418 and the output generator 406. For some types of inputs, contextual processor/router 404 may not perform any processing or updating based on those inputs, but rather those inputs are simply routed to another destination.

Authenticate unit 408 performs an authentication function that involves confirming that the source of the input being provided to microcircuit segment 400 is a trusted and authentic source. Authentication can include but is not limited to: x.509 certificate based authentication, OAuth, and digitally signed documents.

In one embodiment, tokenize/detokenize unit 410 performs a data security function that involves substituting a sensitive data element with a non-sensitive equivalent, referred to as a token, that has no intrinsic or exploitable meaning or value. In one embodiment, values are only partially tokenized so that portions of the information remain unchanged to allow for functions such as verification, routing, etc. In another embodiment, portions of a document may be tokenized (e.g. ISO 20022 messages) where specific sections of the document like the basket data are tokenized. In another embodiment, tokenized values can also preserve their format to enable backwards and legacy system and document format compatibility (e.g., with ISO 8583 messsages). In one embodiment, the tokenize/detokenize unit 410 utilizes memory loops 308 to store keys, tokenization lookup tables based on an array of keys, etc. This approach has both security and performance benefits. The security benefit is that the seed key or lookup tables could never be extracted from the memory on FPGA processor 300, and the performance benefit is that the size of the memory loop 308 can be limited to the scope of the collections of tokenization keys that the lookup table has processed versus a broad matrix. Further, more than one memory loop 308 can be used to buffer the lookup table(s). In one embodiment, based on the received input, the tokenize/detokenize unit 410 identifies the relevant tokenize/detokenize(s) allowable, programs the hardware gates within the FPGA processor based on the cryptography techniques, keys, and lookup table(s) stored in data records 136 and/or the input information to essentially encode those cryptographic tokenization/detokenization configurations and algorithms in hardware, and then processes the input with the hardware version of the tokenization/detokenization cryptography. In one embodiment, during the configuration of the tokenize/detokenize unit 410, one or more cryptography processors can be allocated, with each of the cryptography processors corresponding to one of the identified tokenization/detokenization(s).

In another embodiment, the tokenize/detokenize unit 410 provides deterministic token service provider (TSP) services for financial transactions such as EMV including but not limited to: token generation and issuance, token assurance level rules, payment token processing, detokenization, verifications, payment token vault (history of tokens), payment token limitation rules (e.g. merchant, channel, category, brand, product, etc.).

In one embodiment, similar to or in combination with the currency rules above, payment token limitation rules can have rules attached to the payment token that provide the requirements and limitations for the use of the payment token. Payment token rules can incorporate many allowable or restricted dimensions, including but not limited to and singularly or in combination: currency, quantity, product identifier, service identifier, UPC, collection of UPCs, brand, manufacturer, category, merchant, time, consumer location, device, offer, incentive, nutritional properties, and government assistance approved product list(s) (e.g. Supplemental Nutrition Assistance Program (SNAP) approved product list (APL)). Performing these computationally expensive services deterministically in combination with data protection in microseconds provides all of the parties participating in the transaction great value (e.g., merchants, networks, processors, consumers, brands, and governments).

Validate unit 412 performs a validation function that involves examining the input to determine whether it is valid or invalid. In one embodiment, unit 412 examines the inputs one character at a time as the inputs are streamed in, and if an unexpected character is received, the input is deemed to be invalid. The unit 412 also performs additional validation steps (e.g., property validation, document validation, etc.) incrementally as a given input item is streamed in. It is noted that the validation steps, as well as other steps, may be performed at the same time as the application of business rules to the input or other processing of the input (e.g., simultaneous document validation, property validation, and business rule testing).

Encrypt/decrypt unit 414 uses cryptographic techniques to encrypt and decrypt information within the input. In one embodiment, memory loops 308 can be used by the cryptographic functions to store keys and other cryptographic lookups in a safe manner that is not on disk or memory. In one embodiment, encrypt/decrypt unit 414 utilizes the HSM and/or TSM features described above. In one embodiment, based on the received input, the encrypt/decrypt unit 414 identifies the relevant encryption/decryption(s) allowable, programs the hardware gates within the FPGA processor based on the cryptography techniques and keys stored in data records 136 and/or the input information to essentially encode those cryptographic configurations and algorithms in hardware, and then processes the input with the hardware version of the cryptography. In one embodiment, during the configuration of the encrypt/decrypt unit 414, one or more cryptography processors can be dispatched, with each of the cryptography processors corresponding to one of the identified encryption/decryption(s).

Fraud detect unit 416 performs a fraud processing function that involves applying fraud rules, such as a list of fraud-related accounts, stolen credit cards, etc., In one embodiment, based on the received input, the fraud detect unit 416 identifies the relevant fraud rules, programs the hardware gates within the FPGA processor 300 based on the fraud rules stored in data records 136 to essentially encode those fraud rules in hardware, and then processes the input with the hardware version of the fraud rules. In one embodiment, during the configuration of the fraud detect unit 416, one or more of fraud rule processors are dispatched, with each of the fraud rule processors corresponding to one of the identified fraud rules.

In one embodiment, the fraud rules are coupled with machine learning models that learn behavior patterns from one or more dimensions (e.g. account, location, device, amounts). In one embodiment, input streams of fraud information and models are received from other fraud systems and government agencies. In one embodiment, fraud information and models are streamed out other fraud systems and government agencies. Processing time advantages are essential in monitoring and detecting fraud and low latency, deterministic response can provide the necessary edge to reduce fraud. In one embodiment, a relevant velocity change in the activity and/or typical use pattern variances of an account can adjust the fraud score for an account. In another embodiment, changes in the originating location and/or distance and time between originating location(s) adjust the fraud score of one or more of the account, originating location, originating device/instrument.

The transformer/protector 418 is used to transform and/or protect inputs. In one embodiment, the transformer/protector 418 can skew original input data so as to maintain a certain amount of fidelity such that some information about the input is maintained, while other information is obfuscated. Stated another way, precision with respect to certain informational values is changed so as to ensure that the informational values do not serve as a key between other shared data values. In one embodiment, the transformer/protector 418 uses the business rules related to data among the participants to generate view records per participant that restrict the visibility of data elements associated with the transaction. In another embodiment, participant view records are dynamically generated based on exchange persisted data records not unique to the participant.

Output generator 406 is used to generate outputs that are sent to other microcircuit segments or, if the microcircuit segment is the last segment in a microcircuit 314, to egress 316. For any given input, output generator 406 may or may not generate a corresponding output. The outputs can also be either synchronous or asynchronous depending on the type of input.

The functions elements shown in FIG. 6 are not necessarily performed in the order shown and some or all of the illustrated functions might be performed concurrently. Moreover, microcircuit segments 400 may not include one or more of the illustrated functions.

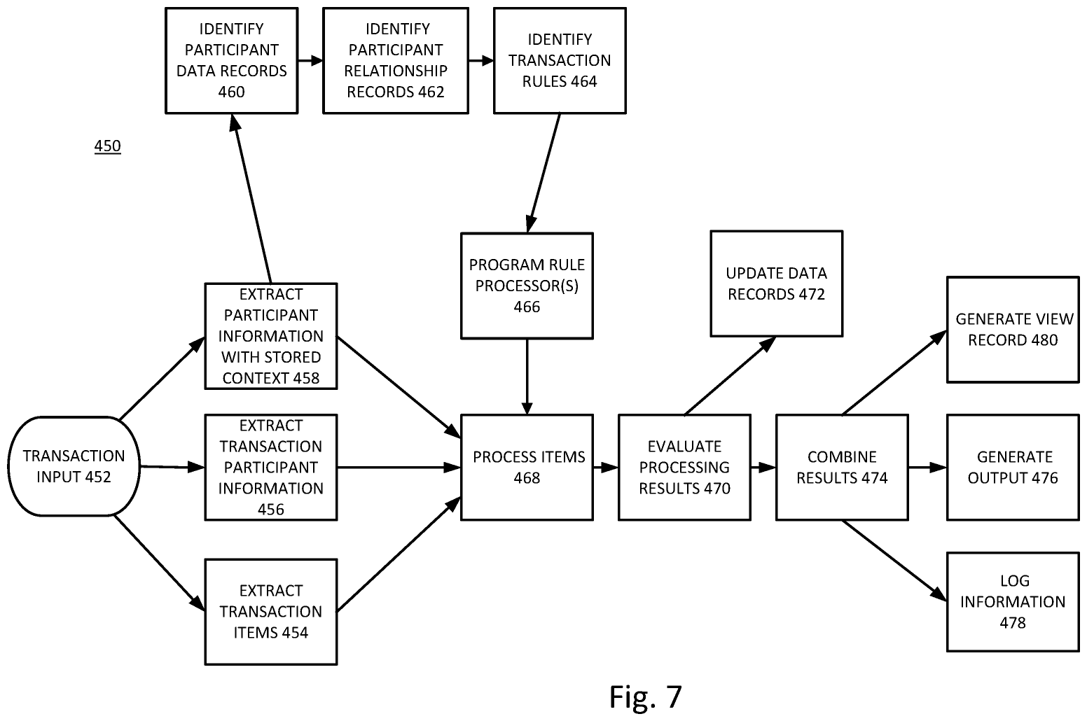

FIG. 7 is a diagram illustrating functions performed by a microcircuit 450 in deterministically processing a financial transaction involving a basket according to one embodiment. A transaction input stream is indicated at 452 and is received by the microcircuit 450. When input stream 452 is received by the microcircuit 450, the microcircuit 450 according to one embodiment evaluates each character of the basket input stream in a state machine as it is streamed through the microcircuit 450. In one embodiment, the transaction input stream 452 is a binary representation of the transaction information.

At 454, the microcircuit 450 extracts items from the received transaction input 452. In one embodiment, the microcircuit 450 also identifies a category for each item in the received transaction information and maintains counts of the total number of items in each of the categories. For a retail store transaction, these counts could include how many times produce came through, how many times toys came through, etc. At 456, the microcircuit 450 extracts participant information from the transaction input 452. In a retail store transaction, this participant information can include a merchant identifier.

At 458, the microcircuit 450 extracts participant information that has stored context from the transaction input 452. Based on the participant information that has stored context, at 460, the microcircuit 450 identifies participant data records. For example, these records can include a participant ID, reserved offers associated with the participant and other data records. Additionally, at 462, participant relationship records are identified. For example, in a retail store transaction, it may be determined at 462 whether a consumer is a member of merchant loyalty program. At 464, the microcircuit 450 identifies transaction rules (stored in data records 136).

At 466, the microcircuit 450 configures a rule processor based on the transaction rules identified at 464. At 468, the microcircuit processes the items (extracted at 454) using the rule processor configured at 468. At 470, the microcircuit 450 evaluates the processing results from the processing performed at 468, for example identifying offers for which a consumer qualified, performing an exclusivity check to identify a best offer in a set of exclusive offers, etc. At 472, the microcircuit 450 updates the data records 136 based on the evaluation at 470, for example by indicating reservations that have been claimed. At 474, the microcircuit 450 can combine results from the evaluation performed at 470. For example, if a number of different offers are utilized, corresponding offer amounts can be added together. At 476, the microcircuit 450 generates an output based on the evaluation at 470 and the combined results at 474. At 478, the microcircuit 450 logs information regarding the processing of the received transaction input.

In addition, at 480, the microcircuit generates one or more view records of the transaction. A view record is a record of specified information that is shared according to data rules.

In one embodiment, each set of transaction rules for a given transaction is represented by a precompiled logic tree that is streamed through the microcircuit 450. The logic tree is stored in data records 136 and is used to program hardware gates within the FPGA processors 300 on-demand during the processing of transaction input 452. This configuration is represented by block 466 in FIG. 6. As an example, one logic tree might indicate that, at the first level, all of the rules must be true. At the next level, a first rule might require that the consumer must be older than 18, and a second rule might require that one of the following things be true: (1) the consumer lives in the state of Minnesota, or (2) the consumer lives in the state of Iowa, or (3) the consumer lives in the state of California. In this example, a consumer must be older than 18 and must live in one of these three states in order to qualify.

During the configuration of the rule processor at 466 in FIG. 6, microcircuit 450 allocates one or more rule processors, with each of the rule processors corresponding to one of the records identified at 460 and 462. In the case of an offer, each rule processor retrieves a precompiled logic tree (stored in data records 136) representing the offer rules for its respective offer and programs the hardware gates within the FPGA processor 300 based on that logic tree. In one embodiment, the rules reside in the memories 302 (e.g., as precompiled logic trees) until needed, and the receipt of a transaction input stream 452 triggers the use of one or more of these rules to program hardware gates within the FPGA processor 300. In one embodiment, the FPGA processor 300 includes a plurality of programmable operator hardware gates having varying bit-widths (e.g., 8-bit, 16-bit, 32-bit, 64-bit, etc.). Each of the operator hardware gates is an expression evaluator, and is configured to apply an operator (e.g., =, >, <, >=, <=, begins With, not, all (logical and), one (logical or)) to a set of operands and returns a result. At 466 each rule processor programs a set of the operator hardware gates based on the precompiled logic tree, such that the set of operator hardware gates can be used to evaluate the set of offer rules for a given offer at 468. After evaluating the set of offer rules, each of the operator hardware gates provides an output indicating the result of the evaluation performed by that operator gate. The results output by the operator hardware gates are then used by microcircuit 450 to determine whether the set of offer rules for the offer has been satisfied.

As the transaction input 452 is streamed through, every item in the transaction goes through every single rule. For example, if a consumer has reserved 100 offers, and the microcircuit includes sixteen rule processors (configured at 466), the first sixteen sets of rules will be used to configure the operator hardware gates, and the input 452 will be streamed through to evaluate those sixteen sets of rules at 468. The operator hardware gates will then be programmed based on the next sixteen sets of rules, and the input 452 is streamed through again to evaluate those sixteen sets of rules. This process is repeated until the 100 sets of rules for the 100 offers have been evaluated. In contrast, if the microcircuit 450 includes 100 or 150 rule processors, the input stream 452 can be streamed through in a single pass, and all 100 sets of rules can be evaluated simultaneously. In one embodiment, microcircuit 450 also performs an exclusivity check (e.g., at 470 in FIG. 6) when multiple offers are satisfied, and determines which of the exclusive offers is best for the consumer.

In one embodiment, microcircuit 450 is programmed to evaluate targeting rules (e.g., rules for identifying target consumers for offers) and other business rules in the same manner as described above for offer rules. Rather than (or in addition to) implementing the offer rules in the operator hardware gates, targeting rules would be implemented in the operator hardware gates and then evaluated. In one embodiment, the rules are used to program hardware gates within the FPGA processor 300 “on the fly” whenever the rules are about to be applied (e.g., when triggered by the receipt of a basket). In another embodiment, each rule may be used to program hardware gates within the FPGA processor 300 any time before application of the rule, such as when the rule first becomes available. For example, the entire set of rules may be used to pre-configure the FPGA processor 300 to evaluate all possible offers.

Microcircuit 450 according to one embodiment deterministically processes financial transactions using in-memory context (e.g., user information and reservations) and in-memory business rules (e.g., offer rules, targeting rules, currency rules, etc.), which are stored in data records 136, and also using in-stream context (e.g., baskets), which is propagated through microcircuit 450 without being stored. In one example, the in-memory context and/or the in-memory business rules are updated by streaming information into microcircuit 450 and updating the in-memory information based on the streamed information. The in-memory context is updated with context streams and the in-memory business rules are updated with rules streams. Event streams contain the in-stream context, and the event streams are not used to update the in-memory information, but rather are used to trigger the application of the in-memory business rules to the in-stream context using the in-memory context. The updating of in-memory information involves create, replace, update, or delete (CRUD) operations.

In the case of a basket, microcircuit 450 identifies the user based on the received basket, identifies the user's data (e.g., reservations), programs the hardware gates within the FPGA processor based on the business rules stored in memory to essentially encode those business rules in hardware, and then processes the basket with the hardware version of the business rules.

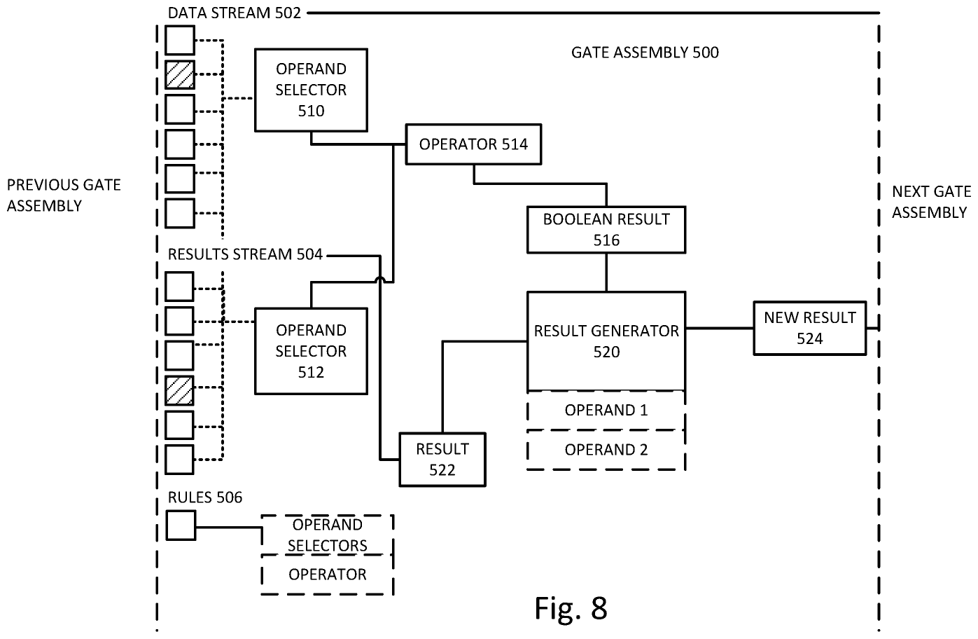

With the above understanding of microcircuit 450 in mind, FIG. 8 provides a schematic flow diagram of a gate assembly 500 having access to data stream 502, results stream 504 and optionally rules 506. During processing through gate assembly 500, a first operand selector 510 extracts from data stream 502 or results stream 504 and a second operand selector 512 extracts from data stream 502 or results stream 504. An operator 514 is pre-compiled or dynamically configured, for example according to rules 506a. Operand selectors 510 and 512 can also be configured by rules 506 as illustrated. Based on an evaluation of the operator 514 with operand selectors 510 and 512, a Boolean result 516 is calculated (i.e., either a 0 or 1) that is transmitted to a result generator 520. Result generator 520 has access to a current result 522 and can furthermore optionally access operand selectors 510 and 512. Result generator 520 produces a new result 524, which is then transmitted along with the original data stream 502 to a subsequent gate assembly.

Various embodiments of the invention have been described above for purposes of illustrating the details thereof and to enable one of ordinary skill in the art to make and use the invention. The details and features of the disclosed embodiment[s] are not intended to be limiting, as many variations and modifications will be readily apparent to those of skill in the art. Accordingly, the scope of the present disclosure is intended to be interpreted broadly and to include all variations and modifications coming within the scope and spirit of the appended claims and their legal equivalents.

1. A method of processing a transaction within a system, comprising:
receiving an input stream comprising transaction information to an ingress of an FPGA processor;
processing the input stream from the ingress to identify one or more microcircuit configurations based on the transaction information;
retrieving from memory connected to the FPGA processor said one or more microcircuit configurations;
programming selected gates of the FPGA processor with said one or more microcircuit configurations;
processing information from the input stream through said selected gates to produce one or more results;
producing an output stream based on said one or more results; and
transmitting the output stream to an egress of the FPGA processor, wherein steps performed from the ingress to the egress are conducted without an operating system.

2. The method of claim 1, wherein said one or more microcircuit configurations represent rules related to sharing information among participants to the transaction.

3. The method of claim 1, wherein said one or more microcircuit configurations represent rules related to transferring ownership of currency among participants to the transaction.

4. The method of claim 1, wherein said one or more microcircuit configurations represent rules related to transferring ownership of tokens among participants to the transaction.

5. The method of claim 1, wherein said selected gates run in parallel with one another.

6. The method of claim 1, wherein said selected gates run serially with one another.

7. The method of claim 1, wherein the selected gates run both serially and in parallel with one another.

8. The method of claim 1, wherein said one or more microcircuit configurations represent rules related to conducting fraud detection related to the transaction.

9. The method of claim 1, wherein said one or more microcircuit configurations represent rules related to identifying activity velocity relevant to the transaction.

10. The method of claim 1, wherein said one or more microcircuit configurations represent rules related to sharing information among participants to the transaction.

11. An FPGA rules processing exchange for processing transactions, comprising:
memory containing a plurality of microcircuit configurations;
an ingress receiving input streams including transaction information;
an FPGA processor connected with the ingress and comprising:
a first microcircuit segment configured to identify one or more microcircuit configurations of the plurality of microcircuit configurations stored in memory based on the transaction information;
a second microcircuit segment configured to retrieve said one or more microcircuit configurations;
a third microcircuit segment programming selected gates of the FPGA processor with said one or more microcircuit configurations;
a fourth microcircuit segment configured to process information from the input stream through the selected gates to produce one or more results, wherein the FPGA processor executes the first, second, third and fourth microcircuit segments without the use of an operating system;
an egress connected with the FPGA processor and configured to produce an output stream indicative of the one or more results.

12. The exchange of claim 11, wherein said one or more microcircuit configurations represent rules related to sharing information among participants to the transaction.

13. The exchange of claim 11, wherein said one or more microcircuit configurations represent rules related to transferring ownership of currency among participants to the transaction.

14. The exchange of claim 11, wherein said one or more microcircuit configurations represent rules related to transferring ownership of tokens among participants to the transaction.

15. The exchange of claim 11, wherein said selected gates run in parallel with one another.

16. The exchange of claim 11, wherein said selected gates run serially with one another.

17. The exchange of claim 11, wherein the selected gates run both serially and in parallel with one another.

18. The exchange of claim 11, wherein said one or more microcircuit configurations represent rules related to conducting fraud detection related to the transaction.

19. The exchange of claim 11, wherein said one or more microcircuit configurations represent rules related to identifying activity velocity relevant to the transaction.

20. The exchange of claim 11, wherein said one or more microcircuit configurations represent rules related to sharing information among participants to the transaction.
